(19) United States
(12) Patent Application Publication
(10) Pub. No.: US 2026/0205856 A1
(43) Pub. Date: Jul. 16, 2026

(54) METHOD FOR TRANSMITTING MEASUREMENT REPORT AND AN APPARATUS THEREOF

(71) Applicant: SAMSUNG ELECTRONICS CO., LTD., Suwon-si (KR)

(72) Inventors: Yeongjun KIM, Suwon-si (KR); Dahae CHONG, Suwon-si (KR); Ki Il KIM, Suwon-si (KR); Seonghwan HYUN, Suwon-si (KR); Beom Kon KIM, Suwon-si (KR); Joohyun DO, Suwon-si (KR)

(73) Assignee: SAMSUNG ELECTRONICS CO., LTD., Suwon-si (KR)

(21) Appl. No.: 19/311,865

(22) Filed: Aug. 27, 2025

(30) Foreign Application Priority Data
Jan. 14, 2025 (KR) 10-2025-0005361

(51) Int. Cl. H04W 24/10; H04B 17/318; H04L 41/16

(52) U.S. Cl. CPC H04W 24/10; H04B 17/328; H04L 41/16

(57) ABSTRACT

A method of transmitting a measurement report (MR) by a terminal in a radio communication system includes obtaining radio signal measurement data by receiving reference signals (RSs) in a set time period, identifying radio signal measurement prediction information based on the radio signal measurement data through a trained model, based on the radio signal measurement prediction information, detecting a pre-event related to a determination on triggering an MR event, and transmitting an MR to a base station (BS) based on a detection of the pre-event.

### CROSS-REFERENCE TO RELATED APPLICATIONS

This application claims the benefit of Korean Patent Application No. 10-2025-0005361, filed on Jan. 14, 2025, in the Korean Intellectual Property Office, the disclosure of which is incorporated herein by reference in its entirety.

### BACKGROUND

### 1. Field of the Invention

Example embodiments relate to an operation method of transmitting a measurement report and an apparatus thereof.

### 2. Description of the Related Art

In a radio communication system, from radio resource management (RRM) perspective, it is important that a terminal transmits a measurement report (MR) and the terminal is managed in a system based on the MR. This maintains network quality by optimizing radio resources, and may improve system capacity and user experience.

Specifically, recent 5G new radio (NR) systems require more sophisticated RRM algorithms to support a large number of connected devices and high-speed data transmission. For example, with the introduction of new concepts such as beam management, multiple TCI state management, and dynamic resource sharing in the 3GPP Release 15 and later standards, the importance of the RRM is increasing.

For this purpose, a more accurate and situation-appropriate RRM method is required.

### SUMMARY

An aspect provides an operation method and a terminal for transmitting an MR based on radio signal measurement prediction information identified through a trained model.

The technical tasks to be achieved by the present example embodiments are not limited to the technical tasks described above, and other technical tasks may be inferred from the following example embodiments.

According to an aspect, there is provided a method of transmitting a measurement report (MR) by a User Equipment (UE) in a radio communication system, the method including obtaining radio signal measurement data by receiving reference signals (RSs) in a set time period, identifying radio signal measurement prediction information based on the radio signal measurement data through a trained model, based on the radio signal measurement prediction information, detecting a pre-event related to a determination on triggering an MR event, and transmitting an MR to a base station (BS) based on a detection of the pre-event.

According to an example embodiment, the RSs may be received according to a first time interval in the set time period, and identifying the radio signal measurement prediction information may include after the set time period, performing radio signal measurement prediction including a reference signal received power (RSRP) prediction according to a second time interval, and identifying the radio signal measurement prediction information based on the radio signal measurement prediction, and the second time interval may be set to be shorter than the first time interval.

According to an example embodiment, transmitting the MR may include, when the pre-event is detected according to a first RSRP identified to be predicted through the RSRP prediction at a first timepoint based on the radio signal measurement prediction information, determining to trigger the MR event, and when the MR event may be triggered, generating the MR based on one or more RSRPs included in the radio signal measurement prediction information that are predicted through the RSRP prediction.

According to an example embodiment, transmitting the MR may include, when the pre-event is detected according to a second RSRP identified to be predicted through the RSRP prediction at a second timepoint based on the radio signal measurement prediction information, receiving a RS at a third timepoint following the second timepoint according to the second time interval, based on an RSRP measured by the RS, determining whether to trigger the MR event, and when the MR event is triggered, transmitting the MR.

According to an example embodiment, transmitting the MR may include, when the MR event is triggered, receiving one or more RSs after the third timepoint according to the second time interval, and based on an RSRP measured by the RS and one or more RSRPs measured by the one or more RSs, transmitting the MR.

According to an example embodiment, transmitting the MR may include setting information that indicates whether an RSRP used for the MR is an RSRP predicted by the RSRP prediction or an RSRP measured by the UE, and transmitting the MR including the set information.

According to an example embodiment, a manner to transmit the MR may be determined differently based on reliability information on a network environment of the radio communication system.

According to an example embodiment, the trained model may correspond to an artificial intelligence/machine learning (AI/ML) model that is trained to output radio signal measurement prediction data at a future timepoint in response to an input of the radio signal measurement data.

According to an example embodiment, the pre-event may occur when a condition is satisfied that is set to determine whether to trigger the MR event based on the radio signal measurement prediction information.

According to an example embodiment, the radio signal measurement data may be stored in a memory buffer of the terminal.

According to an aspect, there is provided a User Equipment (UE) transmitting a measurement report (MR) in a radio communication system, the UE including a transceiver, a processor and one or more memories configured to store one or more instructions. When the one or more instructions are executed by the processor, the processor is configured to obtain radio signal measurement data by receiving reference signals (RSs) in a set time period through the transceiver, identify radio signal measurement prediction information based on the radio signal measurement data through a trained model, based on the radio signal measurement prediction information, detect a pre-event related to a determination on triggering an MR event, and cause the transceiver to transmit an MR to a base station (BS) based on a detection of the pre-event.

According to an example embodiment, the RSs may be received according to a first time interval in the set time period, and identifying the radio signal measurement prediction information may include, after the set time period, performing radio signal measurement prediction including a reference signal received power (RSRP) prediction according to a second time interval, and identifying the radio signal measurement prediction information based on the radio signal measurement prediction, and the second time interval may be set to be shorter than the first time interval.

According to an example embodiment, the transmitting the MR may include, when the pre-event is detected according to a first RSRP identified to be predicted through the RSRP prediction at a first timepoint based on the radio signal measurement prediction information, determining to trigger the MR event, and when the MR event is triggered, generating the MR based on one or more RSRPs included in the radio signal measurement prediction information that are predicted through the RSRP prediction.

According to an example embodiment, transmitting the MR may include, when the pre-event is detected according to a second RSRP identified to be predicted through the RSRP prediction at a second timepoint based on the radio signal measurement prediction information, receiving a RS at a third timepoint following the second timepoint according to the second time interval, and based on an RSRP measured by the RS, determining whether to trigger the MR event, and when the MR event is triggered, transmitting the MR.

According to an example embodiment, transmitting the MR may include, when the MR event is triggered, receiving one or more RSs after the third timepoint according to the second time interval, and based on an RSRP measured by the RS and one or more RSRPs measured by the one or more RSs, transmitting the MR.

According to an example embodiment, transmitting the MR may further include setting information that indicates whether an RSRP used for the MR is an RSRP predicted by the RSRP prediction or an RSRP measured by the UE, and transmitting the MR including the set information.

According to an example embodiment, a manner to transmit the MR may be determined differently based on reliability information on a network environment of the radio communication system.

According to an example embodiment, the trained model may correspond to an artificial intelligence/machine learning (AI/MIL) model that is trained to output radio signal measurement prediction data at a future timepoint in response to an input of the radio signal measurement data.

According to an example embodiment, the pre-event may occur when a condition is satisfied that is set to determine whether to trigger the MR event based on the radio signal measurement prediction information.

According to an aspect, there is provided a radio communication system including a User Equipment (UE), and a Base Station (BS). The BS is configured to transmit reference signals (RSs) to the UE in a set time period, and the UE is configured to obtain radio signal measurement data by receiving RSs, identify radio signal measurement prediction information based on the radio signal measurement data through a trained model, based on the radio signal measurement prediction information, detect a pre-event related to a determination on triggering an MR event, and transmit an MR to the BS based on a detection of the pre-event.

According to example embodiments, it is possible to improve the stability of AI/ML-based RSRP prediction when a terminal performs MR-related operations.

Further, according to example embodiments, in environments where AI/ML accuracy and reliability are high, a terminal can transmit an MR while reducing power consumption and delay in event triggering, and in environments where AI/ML accuracy or reliability is low, the terminal can transmit an MR with a lower possibility of error. Thus, the terminal can reliably perform MR-related operations.

Effects of the present disclosure are not limited to those described above, and other effects may be made apparent to those skilled in the art from the following description.

### BRIEF DESCRIPTION OF THE FIGURES

These and/or other aspects, features, and advantages of the invention will become apparent and more readily appreciated from the following description of example embodiments, taken in conjunction with the accompanying drawings of which:

FIG. 1 illustrates a radio communication system according to an example embodiment;

FIG. 2 is a flowchart of an operation method in which a terminal transmits an MR according to an example embodiment;

FIG. 3 is a diagram illustrating a structure in which a terminal transmits an MR according to an example embodiment;

FIG. 4 is a flowchart of an operation method in which a terminal transmits an MR based on an RSRP predicted by a model, according to an example embodiment;

FIG. 5 is a diagram illustrating an MR being transmitted based on an RSRP predicted by a model according to an example embodiment;

FIG. 6 is a flowchart of an operation method in which a terminal transmits an MR based on a measured RSRP, according to an example embodiment;

FIG. 7 is a diagram illustrating an MR being transmitted based on an RSRP measured according to an example embodiment; and

FIG. 8 illustrates a block diagram of a terminal according to an example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated.

Expression “at least one of a, b and c” described throughout the specification may include “a alone,” “b alone,” “c alone,” “a and b,” “a and c,” “b and c” or “all of a, b and c.”

In the present disclosure, a “terminal” may be implemented as, for example, a computer or a portable terminal capable of accessing a server or another terminal through a network. Here, the computer may include, for example, a notebook, a desktop computer, and/or a laptop computer which are equipped with a web browser. The portable terminal may be a wireless communication device ensuring portability and mobility, and include (but is not limited to) any type of handheld wireless communication device, for example, a tablet PC, a smartphone, a communication-based terminal such as international mobile telecommunication (IMT), code division multiple access (CDMA), W-code division multiple access (W-CDMA), long term evolution (LTE), or the like.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Recently, interest in applying AI/ML to communication systems is increasing, and recently, 3GPP Rel. 19 RAN2 has adopted “AI/ML for mobility” as a new study item. The AI/ML for mobility is a topic that improves the RRM measurement efficiency of terminals by using the AI/ML technology in a mobile environment. The AI/ML-based RSRP prediction, which is introduced as a representative technology of this topic, is a technology that predicts an RSRP of a future timepoint using an AI/ML network that takes RSRP measurement history data as input. The RSRP predicted by AI/ML ensures that there is no delay in event triggering on the network regardless of the measurement cycle, and thus radio link failure (RLF) or handover failure (HOF) is prevented even in environments where terminals move at high speed. Thus, the performance of the terminals may be improved.

From the perspective of triggering an event, in the existing RS measurement method includes calculating an RSRP by measuring an RS according to a measurement cycle, and immediately triggering an event A1 to an event A6 or activating Time-to-Trigger (TTT) based on the calculated RSRP. In the existing RS measurement method, when the measurement cycle is long, the terminal must wait a long measurement cycle to obtain an RSRP, and accordingly triggering an event is delayed, causing a problem that an MR is delayed. However, the method of predicting an AI/ML-based RSRP has the advantage of enabling an MR without significant delay even in environments with long measurement cycles, by making the AI/ML model to predict and output an RSRP at intervals of a regular unit cycle (sample period) that is shorter than a measurement cycle with an input of data on past RSRP measurement history and to trigger an event based on a predicted RSRP.

Hereinafter, example embodiments of the present disclosure will be described in detail with reference to the drawings.

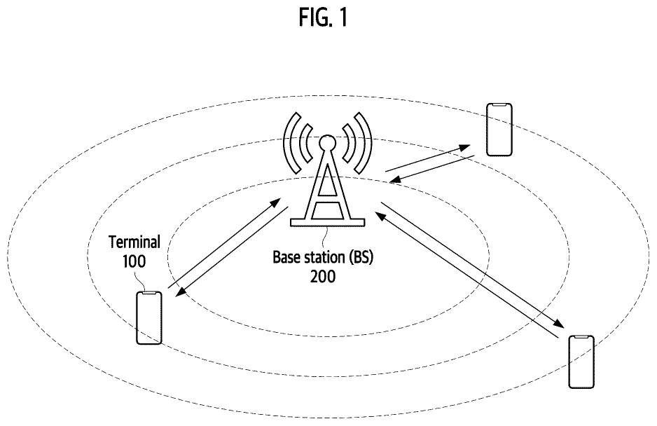

FIG. 1 illustrates a radio communication system according to an example embodiment.

Referring to FIG. 1, the radio communication system may include one or more terminals 100 and a BS 200. Meanwhile, the system depicted in FIG. 1 is illustrated as including only the elements relevant to the example embodiment. Therefore, it will be understood by those skilled in the art related to the present disclosure that other general elements may be included in addition to the elements illustrated in FIG. 1.

According to an example embodiment, as a radio communication apparatus, the terminals 100 which are user equipment may refer to various apparatuses configured to transmit and receive data and/or control information by communicating with other terminals or the BS 200. For example, the terminals 100 may include user equipment, a mobile station (MS), a mobile terminal (MT), a user terminal (UT), a subscribe station (SS), a radio apparatus, a portable apparatus and so on.

According to an example embodiment, the BS 200 may communicate with the terminals 100 to transmit and receive at least one piece of data and control information. For example, the BS 200 may include Node B, next generation Node B (gNB), evolved-Node B (eNB), a base transceiver system (BTS), or an access point (AP).

According to an example embodiment, the terminal 100 may communicate with the BS 200 within the cell coverage of the BS 200. For example, the terminal 100 and the BS 200 may communicate via downlink channel and uplink channel. When communicating over the downlink channel, the terminal 100 may correspond to a radio receiver and the BS 200 may correspond to a radio transmitter. When communicating over the uplink channel, the terminal 100 may correspond to a radio transmitter and the BS 200 may correspond to a radio receiver.

According to an example embodiment, a radio communication network between the terminal 100 and the BS 200 may support communication between multiple users by sharing available network resources. For example, in a network of radio communication systems, information may be transmitted in various ways, such as code division multiple access (CDMA), frequency division multiple access (FDMA), time division multiple access (TDMA), orthogonal frequency division multiple access (OFDMA), and single carrier frequency division multiple access (SC-FDMA).

According to an example embodiment, in the radio communication system of FIG. 1, the BS 200 may transmit RSs to the terminal 100 in a set period of time based on set radio resources. The terminal may receive the RSs from the BS 200 and obtain radio signal measurement data, identify radio signal measurement prediction information based on the radio signal measurement data through the trained model, detect a pre-event that is related to determination whether to trigger an MR event based on the radio signal measurement prediction information, and transmit an MR to the BS 200 based on the detection of pre-event.

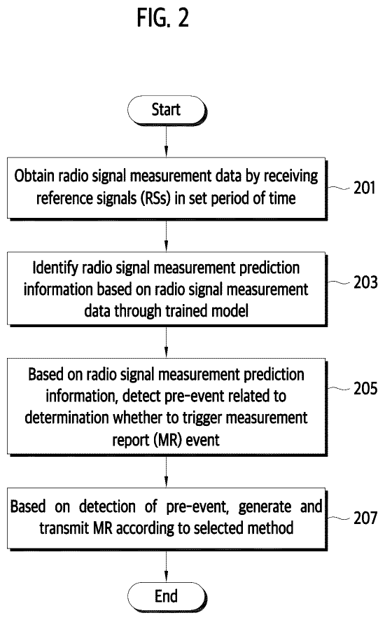

FIG. 2 is a flowchart of an operation method in which a terminal transmits an MR according to an example embodiment.

According to FIG. 2, the terminal 100 may obtain radio signal measurement data by receiving RSs in a set period of time in operation 201, identify radio signal measurement prediction information based on the radio signal measurement data through the trained model in operation 203, detect a pre-event related to determination whether to trigger an MR event based on the radio signal measurement prediction information in operation 205, and generate and transmit an MR according to a method selected based on the detection of the pre-event in operation 207.

The method of operation of the terminal 100 transmitting an MR according to FIG. 2 may correspond to a method for solving stability problems of the AI/ML RRM measurement prediction suggested in 3GPP Rel. 19. In the present disclosure below, “MR event” may include events that cause changes in the network status, such as the six events (the event A1 to the event A6) defined by the 3GPP standard as shown in [Table 1] below. The events that cause changes in the network status may be triggered based on parameters such as the Time-to-Trigger (TTT), which is a timer that sets an event to be triggered when a triggering condition is maintained for a certain period of time.

TABLE 1

| Type | Definition |
|---|---|
| A1 | Serving becomes better than threshold |
| A2 | Serving becomes worse than threshold |
| A3 | Neighbor becomes offset better than SpCell |
| A4 | Neighbor becomes better than threshold |
| A5 | SpCell becomes worse than threshold 1 and neighbor |
| | becomes better than threshold 2 |
| A6 | Neighbor becomes offset better than SCell |

Further, in all example embodiments, an event that occurs by which it is determined that an MR event is to be triggered based on AI/ML-based prediction is described as a “pre-event.” For example, the pre-event may be an event that occurs when a condition is satisfied that is set for determining whether to trigger an MR event based on radio signal measurement prediction information. In an example embodiment, for a predicted RSRP corresponding to a specific timepoint, and identified by the radio signal measurement prediction information, a pre-event may be defined to occur through conditions set in various ways such as 1) a condition where a predicted RSRP value corresponding to a specific timepoint is greater than or equal to a reference value, 2) a condition where a predicted RSRP value corresponding to a specific timepoint becomes less than a reference value, 3) a condition where a predicted RSRP value corresponding to a specific timepoint is greater by a certain level than a predicted RSRP value corresponding to a timepoint prior to the specific timepoint, and 4) a condition where a predicted RSRP value corresponding to a specific timepoint is lower by a certain level than a predicted RSRP value corresponding to a timepoint prior to the specific timepoint. When a pre-event occurs and a set condition is satisfied, the terminal 100 may detect the pre-event.

The trained model used by the terminal 100 to identify radio signal measurement prediction information in FIG. 2 may correspond to an AI/ML model trained to output radio signal measurement prediction data at future timepoints in response to input of radio signal measurement data. In other words, the terminal 100 may be linked to the AI/ML model, the terminal 100 may input radio signal measurement data to the AI/ML model, and the terminal 100 may obtain radio signal measurement prediction data that is output as a response from the AI/ML model. In example embodiments described below, the AI/ML models may perform radio signal measurement prediction at regular time intervals and output a predicted RSRP, and the terminal 100 may identify radio signal measurement prediction information that synthesizes RSRPs predicted by the AI/ML model at the regular time intervals.

Below, example embodiments are described of MR transmission operations based on an RS and an RSRP between the terminal 100 and the BS 200. However, the example embodiments of the present disclosure are not limited to specific RSs and specific RSRPs. According to an example embodiment, the terminal 100 may perform the MR transmission operations based on various types of RS such as a common reference signal (CRS), a demodulation reference signal (DMRS), a channel state information-reference signal (CSI-RS) and so on, and various measurement results such as an RSRP, reference signal received quality (RSRQ), received strength indicator (RSSI), signal to interference plus noise ratio (SINR) and so on identified by receiving the RS, through a manner similar to the technical idea of the present disclosure. In other words, in FIG. 2, the RS received by the terminal 100 may include various types of RS, such as a CRS, a DMRS and a CSI-RS, and the radio signal measurement data obtained by the terminal 100 may include data on various measurement results such as the RSRP, the RSRQ, the RSSI and the SINR. Similarly, the trained model associated with the terminal 100 in FIG. 2 may correspond to an AI/ML model configured to predict measurement results in response to various types of radio signal measurement data such as the RSRP, the RSRQ, the RSSI and the SINR, and output the radio signal measurement prediction data. The radio signal measurement prediction performed by the AI/ML model at regular time intervals may include other predictions such as the RSRQ, the RSSI and the SINR in addition to the RSRP prediction.

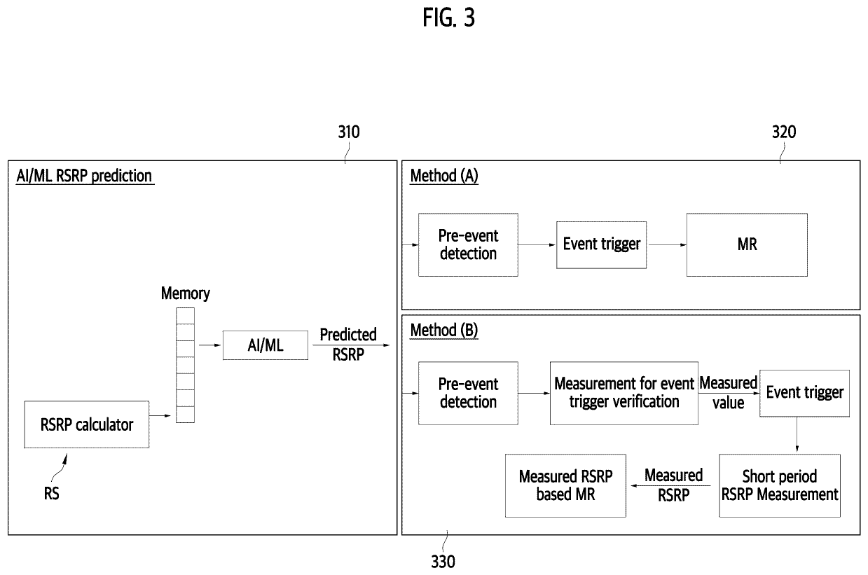

The structure in which the terminal 100 transmits an MR according to the operation of FIG. 2 may have a form similar to FIG. 3.

FIG. 3 is a diagram illustrating a structure in which a terminal transmits an MR according to an example embodiment.

In FIG. 3, the terminal 100 may receive an RS and measure and calculate an RSRP based on RSRP calculator, store a measured RSRP in a memory buffer as measurement history data, and input the data into the AI/ML model. The AI/ML model that received an input of the historical data of radio signal measurements such as the RSRP may output radio signal measurement prediction data including the predicted RSRP for future timepoints (“Predicted RSRP”).

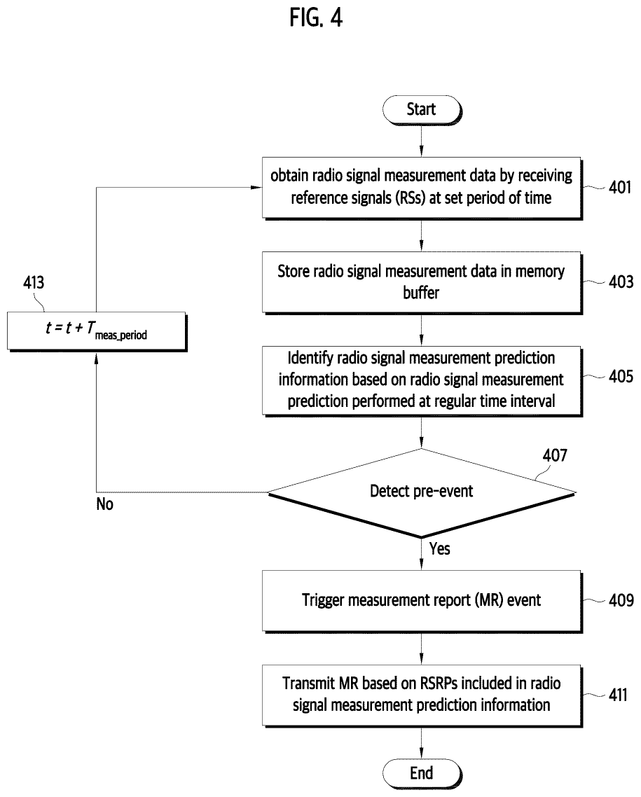

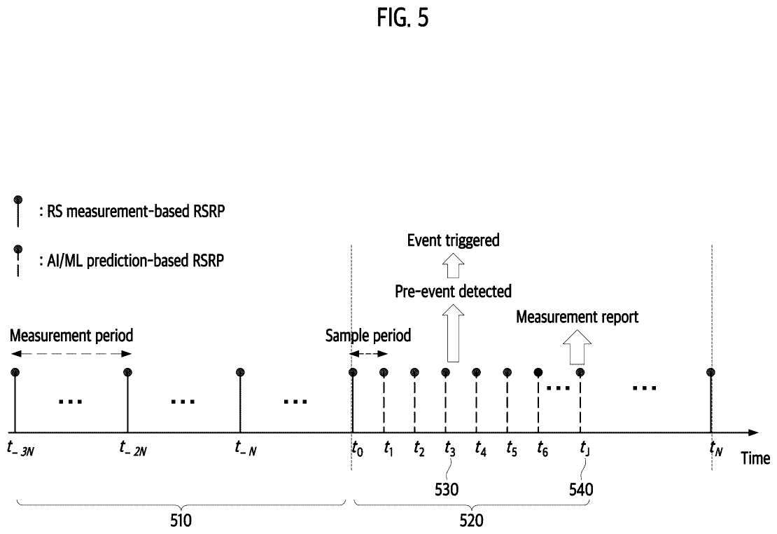

When identifying radio signal measurement prediction information based on the radio signal measurement prediction data, the terminal 100 may detect a pre-event related to determination whether to trigger an MR event (“pre-event detection”), trigger an MR event when a pre-event is detected (“Event trigger”) and generate an MR based on a predicted RSRP (“Predicted RSRP based MR”) as illustrated in reference numeral 320 in FIG. 3. Specific operations for the terminal 100 to perform MR-related operations according to the same method as illustrated in reference numeral 320 in FIG. 3 (“Method (A)”) are described later with reference to FIG. 4 and FIG. 5.

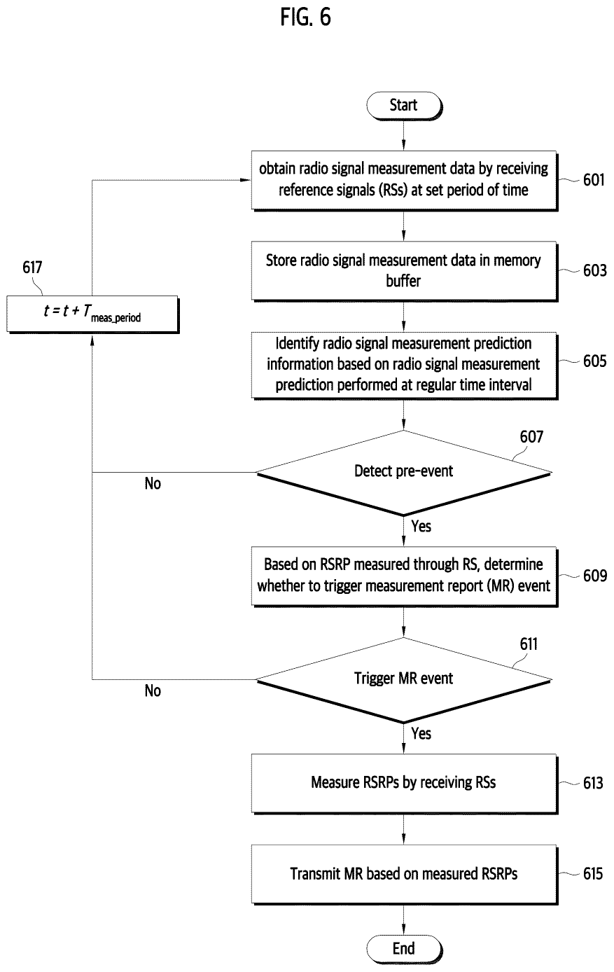

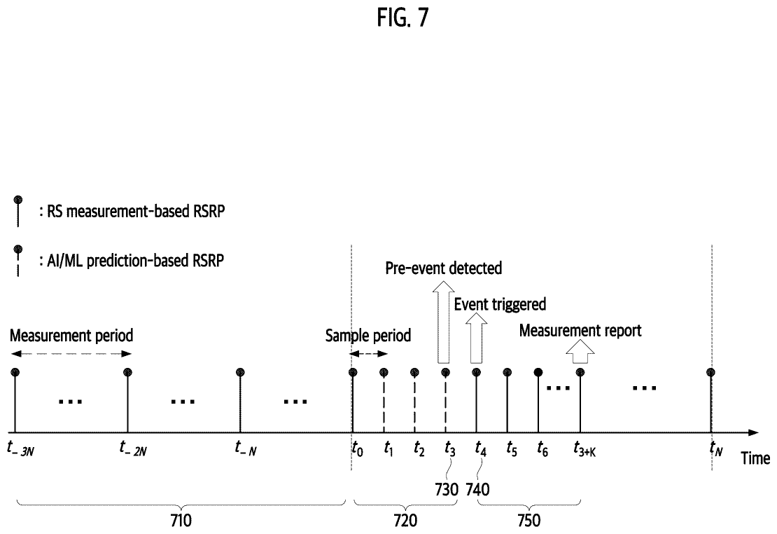

Alternatively, when identifying radio signal measurement prediction information based on the radio signal measurement prediction data, the terminal 100 may detect a pre-event related to determination whether to trigger an MR event (“pre-event detection”), perform RSRP measurement to determine whether to trigger an MR event when a pre-event is detected (“Measurement for event trigger verification”) and trigger an MR event based on the RSRP measurement result (“Event trigger”). When the MR event is triggered, the terminal 100 may perform RSRP measurement for an MR in regular short cycles (“Short period RSRP Measurement”), and generate the MR based on measured RSRP (“Measured RSRP based MR”) as illustrated in reference numeral 330 in FIG. 3. Specific operations for the terminal 100 to perform MR-related operations according to the same method as illustrated in reference numeral 330 in FIG. 3 (“Method (B)”) are described later with reference to FIG. 6 and FIG. 7.

According to FIG. 3, the terminal 100, which obtains radio signal measurement data from the AI/ML model, may perform MR-related operations according to two different MR methods, such as what is illustrated in reference numeral 320 or in reference numeral 330 in FIG. 3. According to an example embodiment, determination may be made by which the terminal 100 performs the MR-related operations according to one MR method that the terminal 100 selected among two MR methods, or determination may be made by which the terminal 100 performs the MR-related operations according to one MR method selected based on external factors among the two MR methods.

In an example embodiment, the terminal 100 may set up a switch structure for two different MR methods, set factors or thresholds for determining whether to perform each MR method, identify whether the factors or the thresholds are met, and perform MR-related operations through one MR method selected in the switch structure accordingly.

In another example embodiment, settings or parameters in the radio communication system network environment for determining the MR method may be defined, and the terminal 100 may also perform MR-related operations via one MR method specified based on the network settings or network parameters defined in this way.

In another example embodiment, the MR method may be determined differently based on reliability information about the network environment of the radio communication system or accuracy information of the AI/ML. Depending on the operation as illustrated in reference numeral 320 in FIG. 3 when the reliability of the network environment or the accuracy of AI/ML is high, or depending on the operation as illustrated in reference numeral 330 in FIG. 3 when the reliability of the network environment or the accuracy of AI/ML is low, the terminal 100 may be determined to perform MR-related operations, respectively. In other words, when the reliability of the network environment or the accuracy of AI/ML is high, the terminal 100 may transmit an MR based on the RSRP predicted by the model, and conversely, when the reliability of the network environment or the accuracy of AI/ML is low, the terminal 100 may transmit an MR based on the directly measured RSRP.

Specific operations of the terminal 100 performing MR-related operations according to the same method as illustrated in reference numeral 320 in FIG. 3 (“Method (A)”) are described with reference to FIG. 4 to FIG. 5, and specific operations of performing MR-related operations according to the same method as illustrated in reference numeral 330 in FIG. 3 (“Method (B)”) are described through FIG. 6 to FIG. 7.

FIG. 4 is a flowchart of an operation method in which a terminal transmits an MR based on an RSRP predicted by a model, according to an example embodiment.

In FIG. 4, the terminal 100 may obtain radio signal measurement data by receiving RSs at a set period of time in operation 401, store the radio signal measurement data in a memory buffer in operation 403, and identify radio signal measurement prediction information based on radio signal measurement prediction performed at a regular time interval after the set period of time in operation 405. Here, as described above, the radio signal measurement prediction in FIG. 4 may be performed by an AI/ML model, and may include RSRP prediction as a representative example.

When a pre-event is detected based on the radio signal measurement prediction information in operation 407, the terminal 100 may trigger an MR event in operation 409, and transmit an MR based on RSRPs included in the radio signal measurement prediction information in operation 411. Here, the RSRPs included in the radio signal measurement prediction information may correspond to RSRPs predicted by the model at regular time intervals. In other words, when a pre-event is detected according to a specific first RSRP that is identified to have been predicted through RSRP prediction at the first timepoint after the set time period, the terminal 100 may determine to trigger an MR event, and when the MR event is triggered, the terminal 100 may generate an MR based on one or more RSRPs predicted through RSRP prediction and included in the radio signal measurement prediction information.

Conversely, when no pre-event is detected based on the radio signal measurement prediction information in operation 407, the terminal 100 may omit the operation of triggering the MR event, and may wait until the next measurement cycle and then start the operation again as in FIG. 4.

A specific example embodiment of the terminal 100 transmitting an MR based on an RSRP predicted by the model of FIG. 4, may be as shown in FIG. 5.

FIG. 5 is a diagram illustrating an MR being transmitted based on an RSRP predicted by a model according to an example embodiment.

In FIG. 5, within a set period of time, the terminal 100 may receive RSs according to a regular first time interval or measurement cycle (a measurement period), and the terminal 100 may obtain and calculate each RSRP 510 for each received RS. The each obtained RSRP 510 may be stored in the memory buffer of the terminal 100 as RSRP measurement data. When it is identified that an RSRP corresponding to a current timepoint (to) is stored, the terminal 100 may use RSRP measurement data as input to the AI/ML model to identify prediction information including RSRPs 520 predicted by the AI/ML model at each future timepoint (t₁, t₂, t₃, . . . and so on) according to a regular second time interval (a sample period). Here, the second time interval during which the AI/ML model is set to predict an RSRP may be set to be shorter than the first time interval during which the terminal 100 received RSs and measured RSRPs within the past configured time period. This may be intended to manage an MR to be performed more quickly through this method than in the existing technology in which an MR is performed through a measurement cycle based on the first time interval.

According to the example embodiment in FIG. 5, at the current timepoint (t₀), the terminal 100 may detect the pre-event by a predicted RSRP 530 corresponding to the timepoint of t₃, and trigger an MR event. When the MR event is triggered, the terminal 100 may transmit an MR 540 to the BS 200 at timepoint t_{J} based on the prediction information including the predicted RSRPs 520 for each timepoint (t₁, t₂, t₃, . . . , t_{J}) according to the second time interval after the current timepoint (to). In other words, the transmission of the MR performed in FIG. 5 may be performed based on the RSRP predicted through the AI/ML model, not performed based on the RSRP measured by the terminal 100.

According to the method of FIG. 4 or FIG. 5, the terminal 100 triggers an MR event immediately when a pre-event is detected by an RSRP predicted for a specific timepoint, and since the terminal 100 transmits an MR based on RSRPs predicted by the AI/ML model, and thus the terminal 100 does not perform any additional RS reception or measurement operations. Accordingly, power consumption may be minimized. However, when there is an error in the RSRP predicted by the AI/ML model according to the method of FIG. 4 or FIG. 5, an error may occur in the triggering of the MR event, or an incorrect MR may be transmitted.

In comparison with the methods of FIG. 4 and FIG. 5, which have the above advantages and disadvantages, the terminal 100 may directly measure an RSRP according to the method of FIG. 6 or FIG. 7 and transmit an MR based on the measured RSRP.

FIG. 6 is a flowchart of an operation method in which a terminal transmits an MR based on a measured RSRP, according to an example embodiment.

In FIG. 6, the terminal 100 may obtain radio signal measurement data by receiving RSs at a set time period in operation 601, store radio signal measurement data in a memory buffer in operation 603, and identify radio signal measurement prediction information based on radio signal measurement prediction performed at a regular time interval after a set time period in operation 605. Operation 601 to operation 605 of the terminal 100 illustrated in FIG. 6 are identical to operation 401 to operation 405 of the terminal 100 described above with reference to FIG. 4. The operations may be common to the operations in the process of the terminal 100 transmitting an MR based on predicted RSRP as in FIG. 4 or the terminal 100 transmitting an MR based on measured RSRP as in FIG. 6.

When a pre-event is detected based on radio signal measurement prediction information in operation 607, the terminal 100 may receive an RS, measure an RSRP, and determine whether to trigger an MR event based on the measured RSRP in operation 609. In other words, the terminal 100 does not trigger an MR event immediately when a pre-event is detected, but the terminal 100 may measure an RSRP to determine whether to trigger an MR event and determine whether to trigger an MR event based on the result of the measured RSRP. When the terminal 100 triggers an MR event based on the measured RSRP result, afterward, the terminal 100 may receive RSs and measure RSRPs from the received RSs in operation 613, and transmit an MR based on the measured RSRPs in operation 615. Unlike in FIG. 4, where the terminal 100 transmitted an MR based on RSRPs predicted by the model, the terminal 100 may measure RSRPs and transmit an MR based on the measured RSRPs in FIG. 6.

In other words, when a pre-event is detected based on radio signal measurement prediction information in operation 607, if a pre-event is detected according to a specific second RSRP that is identified to have been predicted through RSRP prediction at the second timepoint after the set period of time, the terminal 100 may receive RS at the third timepoint following the second timepoint according to a regular time interval at which the radio signal measurement prediction of the AI/ML model is performed, and determine whether to trigger an MR event based on the RSRP measured via the RS received at the third timepoint. When the MR event is triggered, the terminal 100 may additionally receive one or more RSs at regular time intervals after the third timepoint at which radio signal measurement prediction is performed, and may transmit the MR based on the RSRP measured via the RS received at the third timepoint and one or more RSRPs measured via one or more RSs received additionally.

When a pre-event is not detected based on the radio signal measurement prediction information in FIG. 6 in operation 607, or when an MR event is not triggered based on the measured RSRP result in operation 611, the terminal 100 may omit the operation to trigger an MR event, and may wait until the next measurement cycle in operation 617 and then start the operation 601 again as in FIG. 6.

In the example embodiment of FIG. 6, the terminal 100 may use L1 RSRP to determine whether to trigger an MR event, or use other measurement values such as L3 RSRP.

A specific example embodiment of the terminal 100 transmitting an MR based on measured RSRP of FIG. 6 may be as in FIG. 7.

In FIG. 7, according to a regular first time interval or measurement cycle (a measurement period) within a set period of time, the terminal 100 may receive RSs and obtain each RSRP 710 for each received RS. The obtained each RSRP 710 may be stored in the memory buffer of the terminal 100 as RSRP measurement data, and when identifying that the RSRP corresponding to the current timepoint (t₀) is stored, the terminal 100 may use RSRP measurement data as input to an AI/ML model to identify prediction information including RSRPs 720 predicted by the AI/ML model at each future timepoint (t₁, t₂, t₃, . . . and so on) according to a regular second time interval (a sample period). As in FIG. 4, the second time interval during which the AI/ML model is set to predict RSRP may be set to be shorter than the first time interval during which the terminal 100 received RSs and measured RSRP within the past set period of time. This may be intended to manage an MR to be performed more quickly through this method than in the existing technology in which an MR is performed through a measurement cycle based on the first time interval.

According to the example embodiment of FIG. 7, at the current timepoint (t₀), the terminal 100 may detect a pre-event by a predicted RSRP 730 corresponding to a timepoint of t₃, and measure an RSRP 740 to determine whether to trigger an MR event at timepoint t₄ following timepoint t₃ according to the second time interval based on that the pre-event is detected. In other words, in FIG. 7, the terminal 100 does not trigger an MR event immediately even if a pre-event is detected. Instead, the terminal 100 may receive a new RS at a timepoint according to the next time interval and measure an RSRP, and trigger an MR event based on the measured RSRP.

When the MR event is triggered, the terminal 100 may receive a new RS, measure an RSRP at each timepoint (t₅, t₆, . . . , t_{3+K}) according to the second time interval after timepoint (t₄) at which the RSRP 740 is measured, and transmit the MR to the BS 200 at timepoint t_{3+K} based on measured RSRPs 750. In other words, the transmission of the MR performed in FIG. 7 may not be performed based on the RSRP predicted by the AI/ML model, but the MR transmission may be performed based on the RSRP measured by the terminal 100.

In case of following the method of FIG. 6 to FIG. 7, the terminal 100 triggers an MR event and transmits an MR based on the actual measured RSRP. Thus, stability and accuracy of the MR may be improved because the possibility of error is low. However, according to the method of FIG. 6 to FIG. 7, the terminal 100 performs additional RS reception and measurement operations after identifying the predicted information including the predicted RSRP. Accordingly, the terminal 100 according to the method of FIG. 6 to FIG. 7 may consume more power than the method of FIG. 4 to FIG. 5 described above.

The terminal 100 transmitting an MR based on RSRP predicted by the model as in FIG. 4 and FIG. 5 or transmitting an MR based on directly measured RSRP as in FIG. 6 or FIG. 7 may set information indicating whether the RSRP used for the MR is the RSRP predicted through the model's RSRP prediction or whether the RSRP used for the MR is the RSRP measured by the terminal 100, and may operate to transmit the MR including the information that is set in this way. The BS 200, which receives the MR through the operation, may identify whether the MR is set based on the RSRP predicted by the model or based on the RSRP measured by the terminal 100, and may perform different MR processing operations for each case, if required.

Meanwhile, the operations of the terminal 100 to obtain radio signal measurement prediction information and transmit an MR based on the information according to an example embodiment may be performed based on other data as well as radio signal measurement data obtained by receiving RSs. In other words, FIG. 2 to FIG. 7 are described focusing on the operations of the terminal 100 obtaining radio signal measurement prediction information and generate an MR through the AI/ML model based on radio signal measurement data obtained by receiving RSs. However, operations of the terminal 100 are not limited thereto, and the terminal 100 or the AI/IL model may operate to obtain radio signal measurement prediction information and generate an MR based on other data or parameters by which the radio signal measurement status may be identified and/or determined.

In an example embodiment, the terminal 100 or the AI/ML model may obtain radio signal measurement prediction information to predict the radio signal measurement status of the terminal 100 by reflecting data or parameters about an environment or a region where the terminal 100 is located. The data or parameters for the environment or the region where the terminal 100 is located may include data or parameters about an environment or a region where factors that may affect the terminal 100 in predicting the radio signal measurement state are identified, such as 1) data or parameter by which indicated is a state and an environment of the terminal 100 when the terminal 100 is placed in the environment that moves at a speed exceeding a certain level, 2) data or parameter by which indicated is a state and an environment of the terminal 100 when the terminal 100 is placed in an environment set to operate at low power due to low battery, 3) data or parameter by which indicated is a state and a region of the terminal 100 when the terminal 100 is located in a region that is at the edge of the BS 200 coverage region or in a region where the connection to the BS 200 is identified as unstable due to repeated disconnections more than a certain number of times, and 4) data or parameter by which indicated is a state and a region of the terminal 100 when the terminal 100 is located in a region where radio interference due to external factors is identified.

The data or the parameters for an environment or a region may be individually identified through the state of one specific terminal 100 located in the environment or region, or may be identified by comprehensively considering the states of multiple terminals located in the environment or region. For example, with regard to regions where the connection to the BS 200 is identified as unstable due to repeated disconnections more than a certain number of times or regions where radio interference due to external factors is identified, data or parameters related to whether a connection is repeatedly lost or radio interference is detected in the region may be obtained and synthesized from multiple terminals located in the region. If the specific terminal 100 located in the region is to obtain radio signal measurement prediction information during MR transmission, data or parameters obtained and synthesized from multiple terminals may be utilized and reflected in obtaining radio signal measurement prediction information. Further, in order to manage data or parameters obtained and synthesized from multiple terminals, large-scale cloud that collects and stores each data or parameter obtained from each terminal in response to the environment or region may be built and supported.

Regarding the AI/ML-based RSRP prediction for the example embodiments of the present disclosure above, it may be understood that various algorithms discussed in 3GPP Rel. 19 RAN2 may be applied without restrictions. In an example embodiment, pre-event detection using an RSRP may be achieved by directly applying a predicted RSRP value to a rule-based method that triggers an MR event based on existing RS measurement, or may be done using other algorithms such as AI/ML direct event detection.

It is apparent that the example embodiments described in the process of performing the operation method of transmitting the MR by the terminal 100 according to the aforementioned FIG. 2 to FIG. 7 may be combined in various forms.

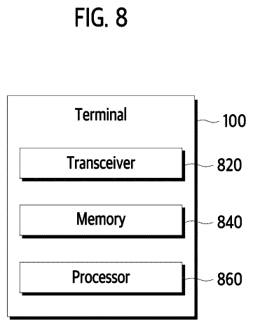

FIG. 8 illustrates a block diagram of a terminal according to an example embodiment.

According to the example embodiment, the terminal 100 may include a transceiver 820, a memory 840 and a processor 860. The terminal 100 illustrated in FIG. 8 shows only the elements relevant to the example embodiment. Therefore, it will be understood by those skilled in the art related to the present disclosure that other general elements may be included in addition to the elements illustrated in FIG. 8. In an example embodiment, the transceiver 820 may be included in a communication device. Further, in an example embodiment, the processor 860 may be included in a controller.

The transceiver 820 is an element for performing radio communication and may communicate with an external terminal or a BS. The external terminal or the BS may be an electronic apparatus or a server. Further, communication technologies utilized by the transceiver 820 may include global system for mobile communication (GSM), code division multi access (CDMA), long term evolution (LTE), 5G, wireless LAN (WLAN), wireless-fidelity (Wi-Fi), Bluetooth, radio frequency identification (RFID), infrared data association (IrDA), ZigBee, near field communication (NFC) and so on.

The memory 840 may be volatile memory or non-volatile memory. The code of the program required to execute the program for the processor 860 to perform the operation of transmitting the MR may be stored in the memory 840.

The processor 860 may control the overall operation of the terminal 100 and may process data and signals. The processor 860 may include at least one hardware unit. Further, the processor 860 may be operated by one or more software modules generated by executing program code stored in the memory 840, and control the overall operation of the terminal 100 and process data and signals by executing program codes stored in the memory 840.

According to example embodiments, the processor 860 may obtain radio signal measurement data by receiving RSs at a set period of time through the transceiver 820, identify radio signal measurement prediction information based on radio signal measurement data through a trained model, detect a pre-event related to determination on whether to trigger an MR event based on the radio signal measurement prediction information, and transmit an MR to the BS 200 based on detection of a pre-event via the transceiver 820.

A terminal according to the above described example embodiments may include a processor, a memory for storing and executing program data, permanent storage such as disk drives, communication ports to communicate with external devices and user interface devices such as touch panels, keys and buttons. Methods implemented as software modules or algorithms are computer readable codes or program instructions executable on the processor, and may be stored on a computer-readable recording medium. Here, the computer-readable recording medium includes a magnetic storage medium (for example, a read-only memory (ROM), a random-access memory (RAM), a floppy disk and a hard disk) and an optically readable medium (for example, a CD-ROM, a digital versatile disc (DVD)). The computer-readable recording medium may be distributed among network-connected computer systems, so that a computer-readable code may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

What is claimed is:

1. A method of transmitting a measurement report (MR) by a User Equipment (UE) in a radio communication system, the method comprising:
obtaining radio signal measurement data by receiving reference signals (RSs) in a set time period;
identifying radio signal measurement prediction information based on the radio signal measurement data through a trained model;
based on the radio signal measurement prediction information, detecting a pre-event related to a determination on triggering an MR event; and
transmitting an MR to a base station (BS) based on a detection of the pre-event.

2. The method of claim 1, wherein the RSs are received according to a first time interval in the set time period,
wherein identifying the radio signal measurement prediction information comprises:
after the set time period, performing radio signal measurement prediction including a reference signal received power (RSRP) prediction according to a second time interval; and
identifying the radio signal measurement prediction information based on the radio signal measurement prediction,
wherein the second time interval is set to be shorter than the first time interval.

3. The method of claim 2, wherein transmitting the MR comprises:
when the pre-event is detected according to a first RSRP identified to be predicted through the RSRP prediction at a first timepoint based on the radio signal measurement prediction information, determining to trigger the MR event; and
when the MR event is triggered, generating the MR based on one or more RSRPs included in the radio signal measurement prediction information that are predicted through the RSRP prediction.

4. The method of claim 2, wherein transmitting the MR comprises:
when the pre-event is detected according to a second RSRP identified to be predicted through the RSRP prediction at a second timepoint based on the radio signal measurement prediction information, receiving a RS at a third timepoint following the second timepoint according to the second time interval;
based on an RSRP measured by the RS, determining whether to trigger the MR event; and
when the MR event is triggered, transmitting the MR.

5. The method of claim 4, wherein transmitting the MR comprises:
when the MR event is triggered, receiving one or more RSs after the third timepoint according to the second time interval; and
based on an RSRP measured by the RS and one or more RSRPs measured by the one or more RSs, transmitting the MR.

6. The method of claim 2, wherein transmitting the MR comprises:
setting information that indicates whether an RSRP used for the MR is an RSRP predicted by the RSRP prediction or an RSRP measured by the UE; and
transmitting the MR including the set information.

7. The method of claim 1, wherein a manner to transmit the MR is determined differently based on reliability information on a network environment of the radio communication system.

8. The method of claim 1, wherein the trained model corresponds to an artificial intelligence/machine learning (AI/ML) model that is trained to output radio signal measurement prediction data at a future timepoint in response to an input of the radio signal measurement data.

9. The method of claim 1, wherein the pre-event occurs when a condition is satisfied that is set to determine whether to trigger the MR event based on the radio signal measurement prediction information.

10. The method of claim 1, wherein the radio signal measurement data is stored in a memory buffer of the UE.

11. A User Equipment (UE) transmitting a measurement report (MR) in a radio communication system, the UE comprising:
a transceiver;
a processor; and
one or more memories configured to store one or more instructions,
wherein, when the one or more instructions are executed by the processor, the processor is configured to:
obtain radio signal measurement data by receiving reference signals (RSs) in a set time period through the transceiver;
identify radio signal measurement prediction information based on the radio signal measurement data through a trained model;
based on the radio signal measurement prediction information, detect a pre-event related to a determination on triggering an MR event; and
cause the transceiver to transmit an MR to a base station (BS) based on a detection of the pre-event.

12. The UE of claim 11, wherein the RSs are received according to a first time interval in the set time period,
wherein identifying the radio signal measurement prediction information comprises:
after the set time period, performing radio signal measurement prediction including a reference signal received power (RSRP) prediction according to a second time interval; and
identifying the radio signal measurement prediction information based on the radio signal measurement prediction,
wherein the second time interval is set to be shorter than the first time interval.

13. The UE of claim 12, wherein transmitting the MR comprises:
when the pre-event is detected according to a first RSRP identified to be predicted through the RSRP prediction at a first timepoint based on the radio signal measurement prediction information, determining to trigger the MR event; and
when the MR event is triggered, generating the MR based on one or more RSRPs included in the radio signal measurement prediction information that are predicted through the RSRP prediction.

14. The UE of claim 12, wherein transmitting the MR comprises:
when the pre-event is detected according to a second RSRP identified to be predicted through the RSRP prediction at a second timepoint based on the radio signal measurement prediction information, receiving a RS at a third timepoint following the second timepoint according to the second time interval;
based on an RSRP measured by the RS, determining whether to trigger the MR event; and
when the MR event is triggered, transmitting the MR.

15. The UE of claim 14, wherein transmitting the MR comprises:
when the MR event is triggered, receiving one or more RSs after the third timepoint according to the second time interval; and
based on an RSRP measured by the RS and one or more RSRPs measured by the one or more RSs, transmitting the MR.

16. The UE of claim 12, wherein transmitting the MR comprises:
setting information that indicates whether an RSRP used for the MR is an RSRP predicted by the RSRP prediction or an RSRP measured by the UE; and
transmitting the MR including the set information.

17. The UE of claim 11, wherein a manner to transmit the MR is determined differently based on reliability information on a network environment of the radio communication system.

18. The UE of claim 11, wherein the trained model corresponds to an artificial intelligence/machine learning (AI/ML) model that is trained to output radio signal measurement prediction data at a future timepoint in response to an input of the radio signal measurement data.

19. The UE of claim 11, wherein the pre-event occurs when a condition is satisfied that is set to determine whether to trigger the MR event based on the radio signal measurement prediction information.

20. A radio communication system comprising:
a User Equipment (UE); and
a Base Station (BS),
wherein the BS is configured to transmit reference signals (RSs) to the UE in a set time period, and
wherein the UE is configured to:
obtain radio signal measurement data by receiving the RSs;
identify radio signal measurement prediction information based on the radio signal measurement data through a trained model;
based on the radio signal measurement prediction information, detect a pre-event related to a determination on triggering an MR event; and
transmit an MR to the BS based on a detection of the pre-event.
